(19) United States
(12) Patent Application Publication
(10) Pub. No.: US 2010/0184009 A1
(43) Pub. Date: Jul. 22, 2010

(54) TEACHING AND ASSESSMENT METHODS AND SYSTEMS

(75) Inventor: Bartek Rajkowski, South Australia (AU)

Correspondence Address: GREENBLUM & BERNSTEIN, P.L.C., 1950 ROLAND CLARKE PLACE, RESTON, VA, 20191, US

(73) Assignee: LEARNINGSCIENCE PTY LTD, South Australia (AU)

(21) Appl. No.: 12/666,347

(22) PCT Filed: Jun. 26, 2008
(86) PCT No.: PCT/AU2008/000927

§ 371 Date: Mar. 23, 2010

(30) Foreign Application Priority Data
Jun. 26, 2007 (AU) 2007903427

(51) Int. Cl. G09B 1/00; G09B 7/00; G09B 5/00

(52) U.S. Cl. 434/159; 434/362; 434/308; 434/335

(57) ABSTRACT

The invention relates to methods and systems for teaching and assessing a set of targets to a student, particularly in the field of literacy. One application of the invention is in teaching sound-symbol relationships. The invention using a rapid learning system, whereby each target is associated with a completion score and a student score. A student is prompted to identify a particular target (from a number of options). When the student correctly identifies a target, the student score is incremented until it reaches a completion score. The student score is decremented for incorrect responses. A support mechanism (e.g. a mnemonic) may be provided to the student—as a student shows increased proficiency, the level of support is reduced. This may be done by “morphing” the mnemonic into a standard representation of the target. Associated methods and systems are also disclosed.

### FIELD OF THE INVENTION

The present invention relates to methods and systems for teaching and assessing a set of teaching targets to a student. The present invention will be described making particular reference to the teaching of sound-symbol relationships in the environment of improving literacy. However, the invention is not limited to this environment, and may be applied to teaching many other types of targets, including other language structures, mathematical constructs, musical constructs, foreign languages and character sets, or specialised terminology.

### PRIORITY CLAIM

This application claims priority from Australian Patent Application No 2007903427, the entire contents of which are hereby incorporated by reference.

### REFERENCES

Throughout the specification, reference will be made to the following documents:
Antonov, I., Antonova, I., Kandel, E. R., and Hawkins, R. D. (2003), “Activity-dependent presynaptic facilitation and Hebbian ltp are both required and interact during classical conditioning in Aplysia” Neuron 37:135-147.
Foy, J. G., & Mann, V. (2001), “Does strength of phonological representations predict phonological awareness in preschool children?” Applied Psycholinguistics 22, 301-325.
Griffiths, Y. M. and M. J. Snowling (2002), “Predictors of Exception Word and Nonword Reading in Dyslexic Children: The Severity Hypothesis” Journal of Educational Psychology March 2002; 94(1):34-43.
Kandel, E R, (2001), “The Molecular Biology of Memory Storage: A Dialogue Between Genes and Synapses” Science 294:1030-1038.
Pulvermuller, F. (1999), “Words in the Brain's Language” Behavioral and Brain Sciences 22, 253-336.
Pulvermuller, F. (2001), “Brain reflections of words and their meaning.” Trends in Cognitive Sciences 5(12): 517-524.
Ramus, F. (2001), “Outstanding questions about phonological processing in dyslexia” Dyslexia, 7, 197-216.
Simpson, S. (2000). “Dyslexia: a developmental language disorder.” Child: Care, Health and Development 26(5): 355-380.
Swan, D. and U. Goswami (1997). “Picture Naming Deficits in Developmental Dyslexia: The Phonological Representations Hypothesis.” Brain and Language 56(3): 334-353.

### BACKGROUND OF THE INVENTION

Word recognition is the most fundamental skill in reading. If the word recognition process is compromised, all reading ability will be significantly affected. In reading aloud, the reader must convert visual representations of spoken language (letters and words) into speech. The orthography of the English language is based on the English phonetic (sound) system, and consequently an understanding of the relationship between the sound structure and letter patterns in English facilitates the breaking of the “code” of written language, allowing the reader to combine letters representing sounds into spoken words, and vice versa.

In the process of acquiring literacy skills, individuals need to learn sound-letter relationships (e.g. that the letter “c” makes the sound /k/, as in “cat”), sound-letter group relationships (e.g. that the letters “s” and “h” together make the sound /sh/ as in “ship”), and sound-word relationships (e.g. that the letters “y”, “a”, “c”, “h” and “t” together make the word “yacht”, which makes the sound /yot/). When students learn to read they must use these relationships to “decode” written words when reading, and to “encode” words when writing, using a using a combination of visual and phonological skills.

Consider the task of reading aloud a word, say “information”, from the perspective of a student reader. If the word is very familiar to the reader, a memory of the sounds to be articulated corresponding to the entire word may be accessed in order to correctly say the word (see FIG. 1, A). However, if the word in unfamiliar, the student must use sound-symbol knowledge to combine the constituent parts together in order to correctly decode the word (see FIG. 1, B). Conversely, if a student wishes to write the word “information”, they may either remember the letters and order of letters which represent it, or they may break the word down into its constituent parts (syllables and sounds) in order to successfully write it.

In practice, people use a combination of ‘whole word’ and ‘sound-symbol’ information in decoding and encoding words in reading and writing. For example, in reading the word ‘yacht’, a student may use phonological information to encode the ‘y’ and ‘t’ (since these letters have direct sound-symbol correspondence), however the ‘ach’ may be remembered as a visual pattern in the centre of the word, since this letter combination does not reflect typical sound-symbol relationships in English. In this way, sound-symbol knowledge and the visual patterns in words form the foundation of successful decoding in reading and encoding in writing.

Research suggests that an understanding of sound-symbol relationships facilitates independent reading and enables a reader to enter words into their ‘mental dictionary’.

It is clear that an understanding of sound-symbol relationships forms a fundamental component of literacy acquisition. However, the learning of these relationships is difficult due to the fact that an association must be made between sounds and symbols with arbitrary relationships (a process which children with learning difficulties in particular find exceptionally difficult). Furthermore, in order to adequately learn sound-symbol relationships, the student must not only be able to remember sound-symbol associations, but be able to discriminate between them.

Closely related to sound symbol knowledge is a key skill thought to have a fundamental relationship with successful literacy acquisition—phonological awareness. Phonological awareness refers to an individual's understanding of the sound structure of language, usually measured by the individual's ability to identify and make changes to phonological sub-structures in language, such as sounds and syllables. Phonological awareness skills include the ability to break words into their component sounds (segmentation), and combine sounds and syllables to form words (blending). A student uses a combination of sound-symbol knowledge and phonological awareness skills to decode words when reading and encode words when spelling.

Sound-letter knowledge and phonological skills combine with ‘instant’ word recognition ability (when a word is already very familiar to the reader) to facilitate successful reading. It is important that students learning to read develop the ability to instantly recognise very common (high frequency) words, particularly those with irregular spelling patterns (such as ‘said’ and ‘by’).

Teaching sound-symbol relationships (the elemental building blocks of reading and writing), strengthening phonological awareness skills, and developing sight word recognition skills pose great challenges to educators.

Furthermore, it is important to be able to determine those students who have learning difficulties at an early stage, so that they can receive extra support and training tailored to their specific profile of strengths and weaknesses and learning needs. There is accordingly a need for means to identify students with language and learning difficulties.

An overwhelming body of evidence supports the view that a general deficit in phonological processing ability (the ability to use the sound structure of a language in order to process information, Simpson, 2000) is the underlying cause of dyslexia (e.g. Foy & Mann, 2001; Swan & Goswami, 1997; Griffiths & Snowling, 2002; Ramus, 2001). This discovery has lead to the hypothesis that dyslexic children have a deficit in their ability to analyse the sound structure of language. The phonological deficit hypothesis predicts that this difficulty is the underlying cause of reading and writing difficulties. The hypothesis is expanded to include an explanation of how phonological processing may be affected—through poorly specified phonological representations, the brain's representations of the sound patterns in language.

Research suggests that progress in literacy is closely related to the quality of the student's phonological representations for both dyslexic and non-dyslexic readers, and this result has been observed across all languages. There is a need for tools to strengthen and evaluate the fundamental skills required for successful literacy acquisition.

### SUMMARY OF THE INVENTION

In a first aspect of the present invention, there is accordingly provided a method for teaching a set of targets to a student comprising:
(a) associating, with each target, a student score and a completion score;
(b) selecting a target for which the student score has not reached the completion score;
(d) prompting the student to identify the selected target;
(e) receiving a student response; and
(f) if the response correctly identifies the selected target, applying a correct response increment to the student score associated with the selected target; or
   if the response does not correctly identify the selected target, applying an incorrect response decline to the student score associated with the selected target.

In some embodiments, the invention may also require the student to discriminate between targets. Accordingly, the method may further comprise:
(c) displaying multiple different targets to the student, including the selected target.

In step (c), the targets may be displayed in a first representation, and in step (d) the student may be prompted by presenting to them a second representation of the selected target.

The first representation may be a visual representation of a letter, and the second representation may be an auditory representation of the sound made by that letter. In this way, the present invention can be used to learn sound-letter relationships. Alternatively, the first and second representations could be:
a letter combination and its associated sound (such as the letter pattern “igh” and the sound /eye/);
a written word and its auditory representation (such as the word “I” and its corresponding auditory representation, /eye/);
a word and its meaning (such as “telephone” and “an electronic device used to communicate over long distances”);
a segmented word to be blended by the student and its corresponding picture (such as “/s/ . . . /p/ . . . /o/ . . . /t/” and a picture of “spot”);
a spoken word and its corresponding segmented form (such as the auditory representation /spot/and the sound/letter combinations for /s/ . . . /p/ . . . /o/ . . . /t/);
a mathematical construct (such as the visual representation “1” and its corresponding auditory representation /wun)/; or
the sound of a musical chord and its corresponding name, or representation on a stave.

This list is clearly non-exhaustive. There may even be more than two representations of each target (for instance, visual, auditory and motor (articulatory) representations of a letter-sound).

Where the student does not correctly identify the selected target, an incorrect response decline may also be applied to the student score associated with any target identified in the student response. Of course, no further incorrect response decline will be applied if the student does not identify a target at all (e.g. they simply ‘time out’).

In some embodiments, (c) displays the first representation of all targets for which the student score has not reached the completion score. This increases the likelihood of identifying which targets the student commonly confuses, and results in the student having to discriminate between commonly confused targets more frequently, leading to a strengthening of weak stimulus/target associations. Additionally, (c) may also display commonly confused targets adjacent to each other in order to facilitate the ability to discriminate between similar targets. Where the first representation is a visual representation, (c) may comprise displaying the targets in a grid pattern. Of course, the position of targets within the grid may change between iterations of steps (b) to (f).

Furthermore, if the response does not correctly identify the selected target, the first representation of the selected target may be presented to the student—i.e. the student is provided with the correct answer. The student can then be prompted again to identify selected target from displayed targets. This can be done simply by matching the respective first representations. In this way, the correct target is reinforced.

The correct response increment and the incorrect response decline will be understood to simply adjust the student score towards or away from the completion score respectively. The amount of the adjustment may vary depending on a number of factors. For instance, the correct score increment may become larger as more correct responses are received consecutively. Similarly, the incorrect response decline may simply reset the student score to its initial value.

In some embodiments, individual correct response increment and an incorrect response decline are associated with each target. This provides additional customisation of the method to suit a particular student's needs. For instance, if a student has difficulty differentiating between the letters ‘b’ and ‘d’, quite a common problem, then the completion score, correct response increment and incorrect response decline for these targets may be set to require a large number of correct responses before the completion score is reached.

A mnemonic may be associated with each target, and representations of the mnemonic are displayed and presented along with each representation of a target. Preferably, the mnemonic is adjustable in strength, and the strength of the mnemonic is adjusted in accordance with the student score for the target in question. The mnemonic may be adjusted in accordance with the second aspect of the present invention described below.

Steps (b) to (f) may be performed iteratively, until the student score reaches the completion score for all targets, or until a certain time limit or error limit is reached.

In a second aspect of the present invention, there is provided a method for teaching a set of targets to a student comprising:
(g) associating a support mechanism with each target, the support mechanism being adjustable in strength and having a strength value;
(h) selecting a target;
(j) prompting the student to identify the selected target;
(k) providing the support mechanism to the student, at a strength corresponding to its strength value, to assist the student to identify the selected target;
(l) receiving a student response; and
(m) if the response correctly identifies the selected target, decreasing the strength value of the support mechanism associated with the selected target; or
   if the student response incorrectly identifies the selected target, increasing the strength value of the support mechanism associated with the selected target.

In some embodiments, the invention may also require the student to discriminate between targets. Accordingly, the method may further comprise:
(i) displaying multiple different targets to the student, including the selected target.

For step (i) the targets may be displayed in a first representation, and the student may be prompted in step (j) by presenting the selected target in a second representation.

The support mechanism may provide support in different ways. For example, it may provide support by providing the student with a part of the correct answer. Alternatively, the support mechanism may be a mnemonic. The mnemonic may be presentable in both a first and second representation. Accordingly, the mnemonic may be displayed along with the first representations of the multiple different targets in step (i), and/or it may be presented along with the second representation of the selected target in step (j). Alternatively, it could be provided separately.

As the strength of the mnemonic is adjusted, the student may gradually be ‘weaned off’ the mnemonic, until eventually no support is needed. Clearly then, the mnemonic may have a ‘zero’ strength wherein it is not displayed or presented at all.

The mnemonic may have many different representations. For example a visual representation of the mnemonic may be used, or an auditory representation, or both representations. For instance, in teaching the association between the sound /d/ and the letter ‘d’, the mnemonic of a dog may be associated with that target. A picture of a “d-shaped” dog may be displayed with a visual representation of the letter ‘d’ in step (m) (possibly even completely obscuring the letter). If the /d/-‘d’ sound-letter association is the selected target, then the sound of the word ‘dog’ may be presented in step (j) along with the sound /d/ (possibly even completely taking the place of the /d/sound). Similarly, the strength of the auditory mnemonic may be adjusted depending on the student's response(s).

The above-described methods could of course also be used to assess a student's ability to identify targets. This would simply entail attributing numerical values to correct or incorrect responses and reaction times, which could then be compared to normative data if desired.

In a third aspect of the present invention, there is provided a system for teaching a set of targets to a student, comprising:
display means for displaying a first representation of the targets;
support means for providing a support mechanism, wherein the support mechanism is adjustable in strength, and the support means allows provision of the support at a variety of strength values.

Accordingly, the system may simply be a set of ‘blocks’ that children commonly play with. For example, for teaching letters, on each side of a block a letter may displayed along with an associated mnemonic, wherein the mnemonic is displayed at a different strength on each side.

Preferably, the system further comprises:
presentation means to present a second representation of a selected target to the student, for the student to identify the selected target from targets displayed by the display means;
response means to receive a student response; and
a processor to determine whether the response correctly identifies the selected target.

The processor may also be further adapted to associate, with each target, a student score and a completion score, and to apply a correct response increment or an incorrect response decline to the student score, depending on the student response.

In a fourth aspect of the present invention, there is provided a method of assessing a student's ability to recognise representations of a set of targets, comprising:
(n) selecting a target;
(o) displaying multiple response options, each response option known by the student to correspond to a target, one response option corresponding to the selected target;
(p) for a given time, displaying a representation of the selected target to the student;
(q) receiving a student response, from the response options;
(r) determining whether the student response correctly identifies the response option corresponding to the selected target; and
(s) repeating steps (n) to (r), varying response options in step (o) to vary the similarity of the corresponding targets.

The number of response options presented may vary in accordance with the present invention. There may only be two response options presented—a correct response and an incorrect response option. Preferably, the two response options are selected to be similar such that they are a minimal pair.

The targets associated with the response options may be similar in aspects other than those specifically displayed for the selected target. For instance, where the visual representation is displayed to the student, the targets associated with the displayed response options may be similar in their auditory representations.

Furthermore, the similarity of the response options may be varied based on similarity criteria—e.g. based on the visual or auditory similarity of a word. Student performance can then be categorised based on the similarity criteria—e.g. that a particular student more readily discriminates between targets that are visually similar than auditorily similar.

In a fifth aspect of the present invention, there is provided a method of assessing a student's ability to recognise representations of a set of targets, comprising:
(n) selecting a target;
(o) displaying multiple response options, each option known by the student to correspond to a possible target, one option corresponding to the selected target;
(p) for a short time, presenting a representation of the selected target to the student;
(q) receiving a student response, from the possible response options; and
(r) determining whether the student response correctly identifies the selected target, wherein the representation of the selected target displayed in step (n) is degraded.

Preferably, in accordance with fourth and fifth aspects of the present invention, the methods are repeated for many selected targets, and the error rates and response times of the student are logged. The application of the present invention to the environment of literacy means that the phonological representations of the student can be assessed.

In a sixth aspect of the present invention, there is provided a system for assessing a student's ability to recognise representations of targets, comprising:
means for displaying response options;
means for displaying a representation of a target;
means for receiving a student response; and
a processor to analyse the student response to monitor error rates and/or response times.

In a seventh aspect of the present invention, there is provided a computer system for teaching a student to recognise letter combinations comprising:
means to display a word, the word comprising a sequence of letter combinations; and
means to allow a user to obscure parts of the word to isolate one or more of the letter combinations.

‘Word’ in the context above includes made-up or “nonsense” words, which have no meaning in language, but which are useful for illustrating the use of letter combinations in written language. Each letter combination may comprise one or more letters, e.g “ch”, “anon”, etc.

In further aspects of the present invention, there are also provided computer readable media and computer program elements for directing a programmable device to perform the steps of the above methods. Yet further aspects of the present invention will be revealed throughout this specification.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 depicts different representations of the word “Information”;

FIG. 2 is a table showing a set of targets with associated properties;

FIG. 3 is a flow chart of steps (b) to (f) of a method according to an embodiment of the first aspect of the present invention;

FIG. 4a depicts displayed visual representations of a set of letters;

FIGS. 4b and 4c depict displayed visual representations of alternative types of targets;

FIG. 4d depicts displayed visual representations of a set of letters, after an incorrect student response is received;

FIG. 4e depicts an alternative format for presenting a selected target to a student;

FIGS. 5a, 5b and 5c are examples of different mnemonic strengths, according to an embodiment of the second aspect of the present invention;

FIG. 5d shows a number of displayed representations of targets with associated mnemonics at different strengths;

FIG. 6 is an example of a block, according to an embodiment of the third aspect of the present invention.

FIG. 7 is a flow chart of a method according to an embodiment of the fourth or fifth aspects of the present invention;

FIG. 8 is a display of two response options according to an embodiment of the fourth or fifth aspects of the present invention;

FIG. 9 is a display of the two response options of FIG. 7, with a displayed representation of a selected target;

FIG. 10 represents the response of a neuron assembly in the brain upon recognition of a stimulus, where the stimulus is a triangle;

FIG. 11 represents the visual-auditory-motor (VAM) model of phonological representations;

FIG. 12a is a display of the two response options of FIG. 7, with a degraded representation of a selected target;

FIG. 12b is a display of the two response options of FIG. 7, with a further degraded representation of a selected target; and

FIGS. 13 to 15 depict the working of the computer system of the seventh aspect of the present invention.

### DETAILED DESCRIPTION

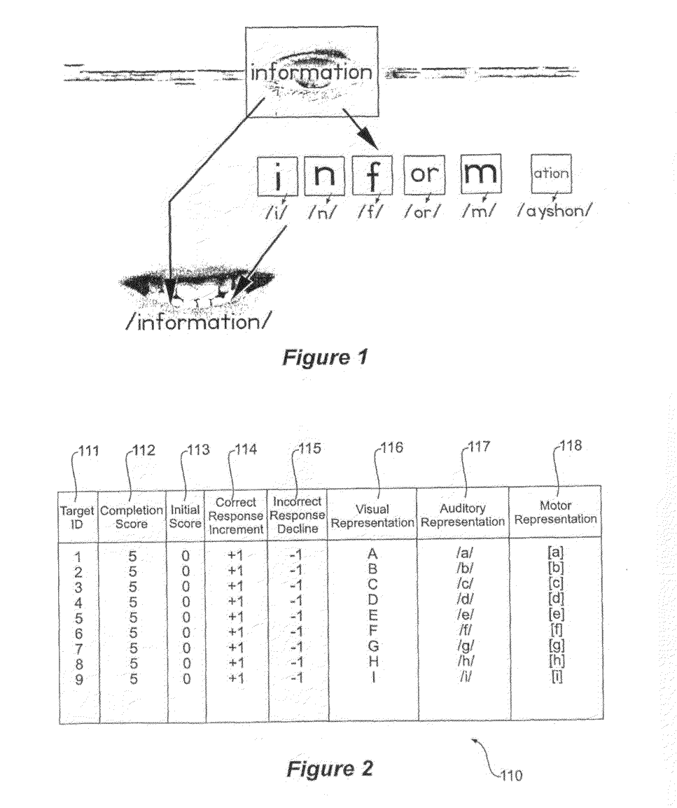

Embodiments of the present invention will now be described in detail with reference to the teaching of written letters and letter combinations. FIG. 1 depicts three representations of the word “information”. The visual representation, depicted top, is the sequence of written letters “information”. Broadly speaking, a person without specific reading difficulties who is learning to read will usually have adequate understanding of spoken words, both in the audible sounds a word makes (depicted middle) and the way the word is articulated by a human mouth (depicted bottom). For such a student, the task of learning to read therefore includes learning the relationships between the visual representations of the sound structure of language (letters and letter combinations) and the auditory or articulatory (or motor) representations. In doing so, the student must learn the various letter-sound patterns and be able to discriminate visually and auditorily between them in order that they are not confused with each other. Students with literacy difficulties may have compromised auditory, visual and/or articulatory representations of words (and smaller phonological structures), making the task of learning letter-sound relationships and decoding more difficult. Letter-sound relationships, having visual and auditory representations, are targets that may be taught using a method according to the present invention.

### First Aspect

FIG. 2 depicts in a table (or as a “matrix” 110) a set of nine targets, corresponding to the first nine letters of the alphabet. Each target has a target ID 111, and associated with each target there is a completion score 112, an initial score 113, a correct response increment 114, and an incorrect response decline 115. Furthermore, each target also has a visual representation 116, an auditory representation 117 and a motor representation 118—target 1 has visual representation “A” auditory representation /a/, and articulatory representation [a], target 2 has visual representation “B”, auditory representation /b/, articulatory representation [b], and so on. Also associated with each target (although not shown in FIG. 2) is a student score, which is initially set to the initial score.

In the matrix shown in FIG. 2, each of the targets has the same values for the completion score, initial score, correct score increment and incorrect score decline. However, in this embodiment, each of these values may be changed to correspond to a particular student's requirements.

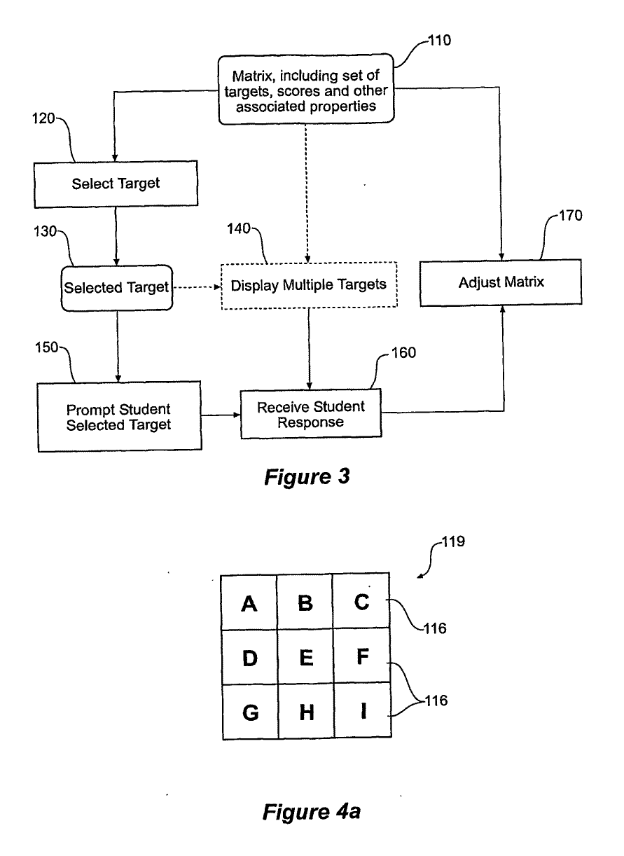

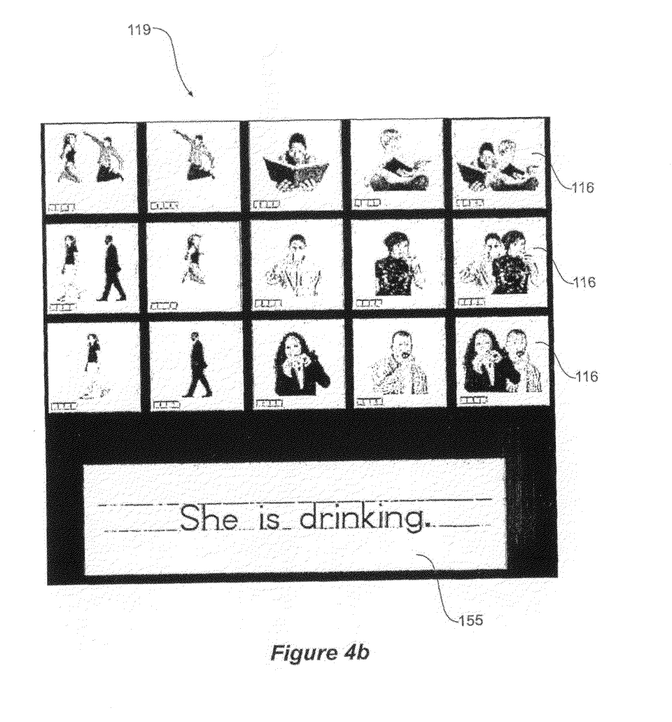

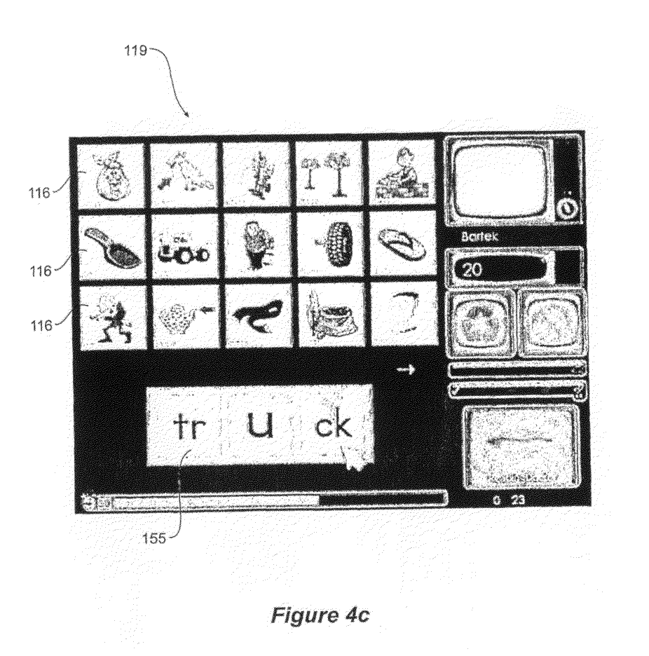

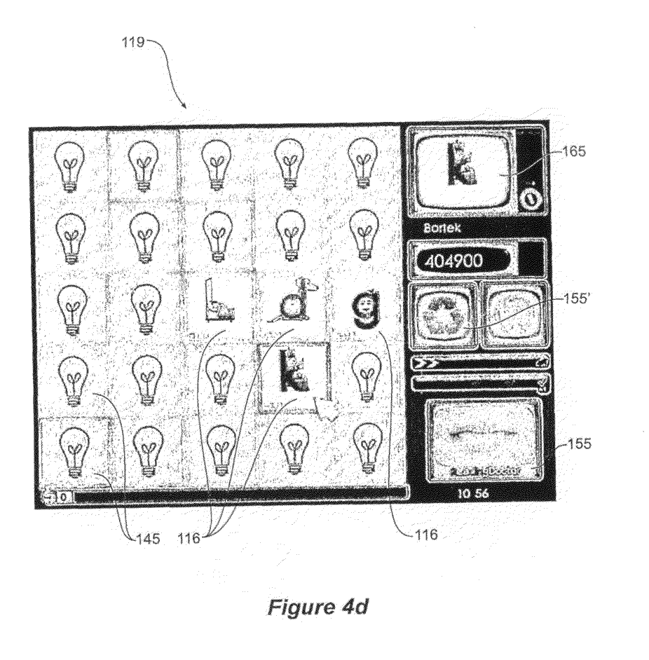

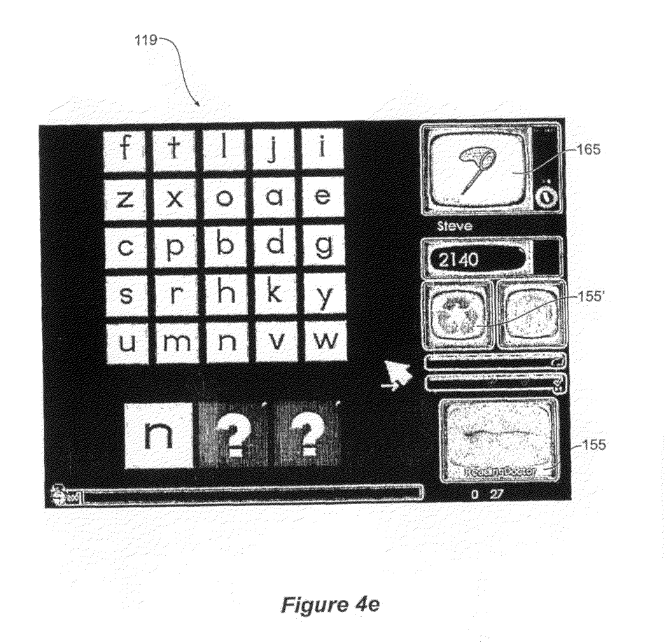

FIG. 3 shows how the matrix depicted in FIG. 2 is utilised in accordance with the first aspect of the present invention. The visual representations of all of the targets are displayed 140 for the student on a computer screen, in a grid pattern 119 as shown in FIG. 4a. A selected target 130 is selected 120 from the matrix 110, for a target for which the student score has not reached the completion score. The selected target 130 should be a target that is displayed 140 to the student; however, in this embodiment, all selectable targets (for which the student score has not reached the completion score) are displayed 140 to the student, as shown in FIG. 4a. Accordingly, in this embodiment, there is no need to determine the selected target before displaying 140 the representations.

In some embodiments, particular types of targets may be displayed in groups. For example, when teaching English letter-sound relationships, vowels only may be displayed to begin with. The number of displayed letters may be increased as the student shows increased proficiency.

The student is them prompted 150 to identify the selected target 130 from the displayed targets. This is done by presenting another representation of the selected target to the student. If, for instance, target 1 is selected, then the student will be prompted by the playing of a recording of the sound /a/ (the auditory representation), and/or displaying the motor representation 155 to the student (either one or both of these representations may be presented in accordance with the present invention). The student should then identify the letter A from the grid 119 displayed in FIG. 4.

A student response is then received 160, for example by a mouse click on one of the letters 116 in the grid 119. This response is analysed and then used to adjust 170 the matrix, by adjusting the student score associated with the selected target 130. If the response is correct, the associated student score is adjusted upwards by the correct response increment (+1 in this case). If the response is incorrect, then an incorrect response decline (−1 in this case) is applied to both the student score associated with the selected target 130, and the student score associated with the (incorrectly) identified target.

The above-described cycle can then be repeated until the student score reaches the completion score for all targets, or until a specified time limit or number of errors is reached.

Many variations on the above-described method are possible. By way of example, the values in the matrix 110 may be varied depending on factors such as the types of targets taught, or the abilities of the student. For instance, the completion score may be increased for difficult targets, or the incorrect score decline may always simply reset the student score to its initial score (which in this case is ‘0’). This increases the number of times the student must correctly discriminate between confused targets.

The target selection step 120 may also be varied to more often select targets with which the student has difficulty.

The target display step 140 is optional—for instance, a student could be prompted by a visual representation of ‘A’ on the screen, and be required to identify the target by saying the sound /a/(which could be received, by a computer system, using a microphone and speech recognition software). Furthermore, the target display step 140 may also be varied in many ways. Representations of all targets need not be displayed—only a portion of the total number may be displayed, including the selected target. This would be particularly appropriate where the number of targets to be learnt is very high. One way of choosing which targets to display would be to only display those targets for which the student score has not reached the completion score. In this way, targets could be gradually removed from the grid 119 shown in FIG. 4a, as the student shows competence in identifying that target. These completed targets may in some embodiments be replaced in the grid 119 by blank tiles or other types of place holders 145. By not selecting targets for which the student score has reached the completion score, and not displaying those targets in the grid 119, the present invention helps to isolate the targets with which a student is having difficulty. The student is given more practice for these targets. Information regarding student responses may also be logged, to observe response times and error rates—this helps to identify where a student is having most difficulty, and can be used to generate new activities base on the student's difficulties, or to see how the student's performance compares with normative data.

Of course, the displayed targets need not be arranged in a grid, as many different arrangements will suffice. They may not even be displayed in visual representations—for instance, they may be displayed in auditory form. However, it will often be appropriate to place easily confused representations adjacent to each other (such as “b” and “d”), to help the student learn to distinguish between them. Again, data may be logged for an individual student to determine those targets most often confused.

The step of prompting the student 150 may be repeated if required. For instance, if the student did not hear the auditory prompt the first time, they may need it to be repeated before they can identify the selected target. In this embodiment, they can request the audio prompt to be replayed by clicking on the associated replay button 155′. In this embodiment, both an audio prompt (repeatable by pressing replay button 155′) and an articulatory prompt 155 are used.

When receiving the response, a time limit may be applied. If the student does not respond within the necessary time frame, then the response will be recorded as not correctly identifying the selected target, and the incorrect score decline applied to the selected target.

The present invention may be used for a wide variety of different targets. FIG. 4b shows a display that might be used to teach the pronouns “he”, “she” and “they” in the English language. FIG. 4c shows a display that might be used to teach word blending and recognition, using a set of words.

FIG. 4d shows displayed representations of a set of letters, similar to the display in FIG. 4a. However, there are two differences that should be noted, because they show variations possible within the scope of the present invention.

Firstly, many tiles 145 of the grid 119 show light bulbs, instead of letters. This is because the student score associated with the corresponding target has reached the completion score, as described above. Therefore, these targets (letters) have been removed from the grid 119, and replaced with place holding tiles 145.

Secondly, FIG. 4d is a screenshot from a computer system employing the method of the present invention, after an incorrect student response. In this embodiment, the selected target is now presented to the student, in a visual representation—i.e. the student is provided with the correct answer. The letter ‘k’ (with the mnemonic of a “king”) is depicted in a box 165 at the top-right of screen. This prompts the student to again identify the selected target from the displayed targets—this can now be done simply by matching the respective first representations (i.e. finding and identifying the ‘k’ and “king” shown top-right). The letter may also be accompanied with the auditory representation of the target. In this way, correct identification of the target is reinforced.

Depending on the type of target being taught, the targets may be taken from a library of possibilities. For example, where whole words are being taught, easily confused words may be extracted from a larger library of whole words, based on visual or auditory similarity (e.g. “here and “hear”) or based on other specific criteria (e.g. ‘all 1 syllable words with 3 sounds and 4 letters, containing the letters ‘ch’ at the beginning of the word). They may be extracted based on their frequency of use in language. The extracted targets may be chosen based on the particular student's prior performance in this or similar exercises.

### Second Aspect

The method described above may be enhanced by the use of support mechanisms, in particular mnemonics, in accordance with the second aspect of the present invention. In this embodiment, each target is further associated with a mnemonic which is adjustable in strength. The student is then asked to identify the target (as described above), and the strength of the mnemonic is adjusted based on the learner's performance. Eventually, the mnemonic may be removed completely, once the student has performed to a sufficient standard.

The target(s) to be learned are initially displayed with corresponding information (e.g. the mnemonic) that facilitates the successful recognition of the target. The purpose of the system is to initially form an association between the mnemonic and the target in the student. The strength of the mnemonic is reduced with successive correct identifications of the target by the student, and increased following unsuccessful identification. If this is used in combination with the method of the first aspect of the present invention, then the student score may be used as a strength value for the associated mnemonic (of course, higher student scores in this case would correspond to lower mnemonic strength). Alternatively, a separate field for strength values associated with each target and mnemonic may be provided within the matrix 110.

Within the context of the invention, a support mechanism may be defined as information separate to the target, which is paired with the target in order to facilitate correct recognition of the target.

This may be achieved through the formation of an association by the learner between a mnemonic and the target. In addition to facilitating correct recognition, the support mechanism may highlight characteristics of the target which are important distinctive features for discrimination or complete recall of the target (for example, using a colour to highlight the shape of a word or an unusual spelling pattern).

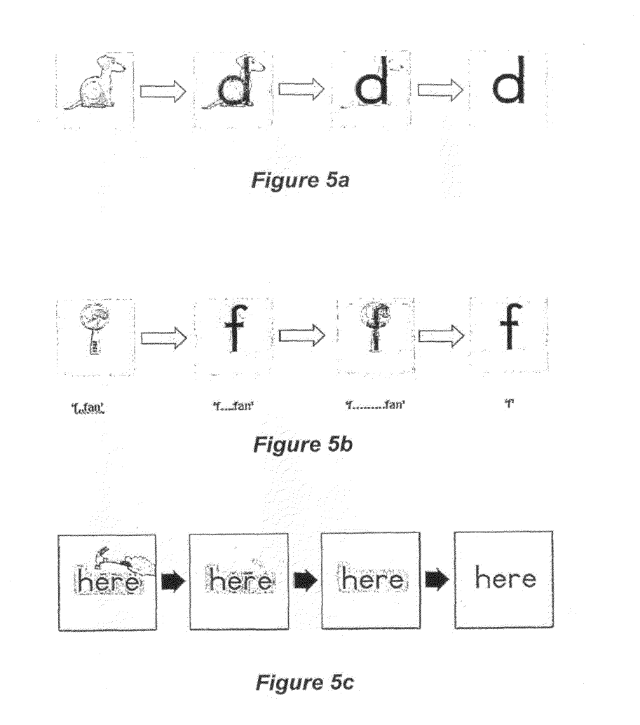

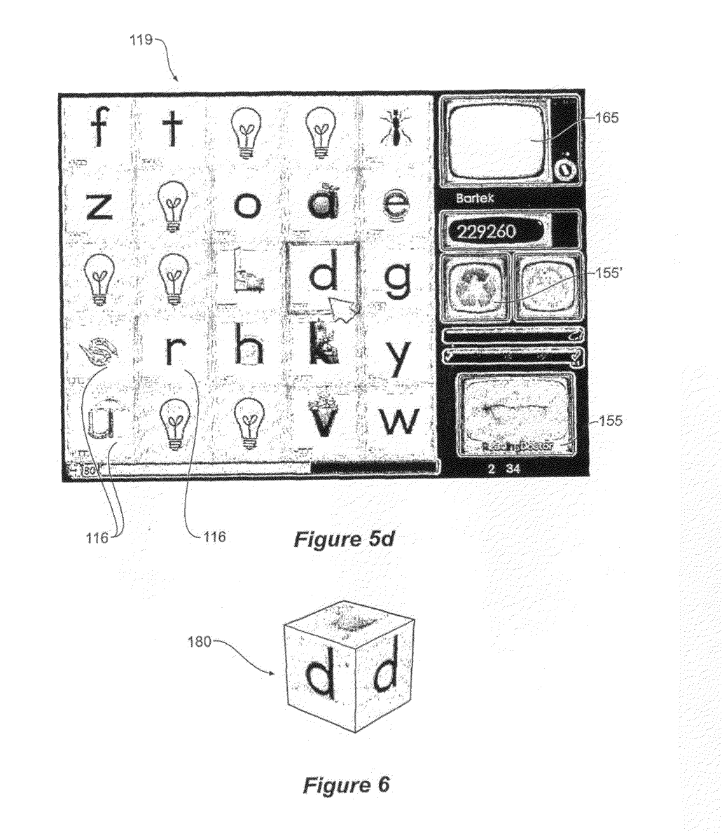

A mnemonic may be visual (such as a picture accompanying a written target), auditory (such as a spoken word or sentence accompanying a written target) or motor (such as a video of the movement of the articulators accompanying a spoken sound, when the objective is to identify a sound corresponding to a letter), or a combination of these. For instance, if the target is the letter ‘d’, a picture of a dog and/or the sound of the word dog may be associated with that target.

Where multiple targets are displayed to the student 140, the presentation of the mnemonic may be done simultaneously or side-by-side with the displayed targets, as appropriate to the display type (e.g. visual or auditory). Alternatively, the displayed target representations may be gradually changed from being the mnemonic to being the ‘normal’ representation of the target, as correct responses are received. Incorrect responses will result in the reverse transition. FIG. 5a shows how a picture of a dog may be transitioned into the letter ‘d’. Auditory mnemonics may also be changed in strength and transitioned into the target, such as changing from the sound /dog/, to saying /d. dog/, to just saying /d/.

For example, in teaching the /d-‘d’ sound-letter association, the initial auditory presentation to the subject may be /d. dog/. As the subject correctly identifies the target, the time between the target (/d/) and the mnemonic (/dog/) may increase (see FIG. 5a), with the target (/d/) eventually presented on its own following the required number of correct responses.

FIG. 5b shows the same progression with the letter ‘f’ and a picture of a fan.

FIG. 5c depicts a further example, where a sentence mnemonic is used during a sight word recognition activity. The target sight word, ‘here’, is associated with a picture of a hammer, and the sentence “Here. Here is a hammer.” is used as a mnemonic. Note also that this example also includes a visual mnemonic highlighting the important visual characteristics of the word (in this case, the shape of the word and the ‘irregularly spelt’ part of the word).

Using this technique, the student may gradually be ‘weaned off’ the mnemonic, until eventually no mnemonic is needed to successfully identify or recall the target. FIG. 5d shows displayed targets with associated mnemonics at various different strength levels. There could of course be corresponding levels of support in the auditory support mechanism, therefore meaning it is also adjustable in strength.

The present invention may be used to teach many different types of targets. A non-exhaustive list of possible target types includes not only letters and their corresponding sounds (e.g. “c” says the sound /k/), but also:
letter combinations and their corresponding sounds (e.g. “igh” says the sound /eye/);
words and their corresponding pronunciations (e.g. “said” says the sound /sed/);
symbols and their corresponding pronunciations (e.g. the phonetic symbol /□/says the sound /sh/);
words and their corresponding definitions (e.g. the word “triangle” means “a closed shape with three straight sides”);
visual depictions of targets (such as concepts, faces, or objects), and their corresponding words; and
other targets such as musical chords and their corresponding names or finger patterns.

In another example, referring again to FIG. 4b, there is shown a display that might by used to teach the pronouns “he”, “she” and “they” in the English language. The initial prompt may be “She is drinking means the girl is drinking”, in both auditory and visual forms. The mnemonic might be gradually weakened by introducing a delay between “She is drinking” and “the girl is drinking”, i.e. “She is drinking . . . the girl is drinking”. The delay may be increased until “the girl is drinking” is removed and only “She is drinking” is displayed and/or said.

More complex stimuli presentation and mnemonic adjustment methods may be used. For example, the present invention may be used to teach blending skills. A set of words to be blended is selected either automatically or by the user. FIG. 4c shows a possible set of words.

The student is presented with picture representations of the words to be blended (“truck” in the example shown). A word to be identified is selected by the system. The word is presented to the student as separate ‘tiles’ corresponding to individual or groups of letters which represent the sounds in the word. The student is required to combine the sounds in the word together in order to correctly identify the corresponding picture. The support mechanism is provided by the system as discussed above. However in this case, the support mechanism is not applied directly on the available targets, but to the information presented to the student to prompt them to identify a target. The various strengths of the support mechanism used to help the student identify the target for selection may be in the following order (from ‘strongest’ (1) to ‘none’ (4)):
1) Visually highlight each letter-sound tile in order and present the corresponding sounds auditorily to the student, while displaying visual mnemonics reminding the student of the corresponding sounds on each tile. Present the blended word. (e.g.
2) The student may move the computer mouse over the letter-sound tiles. Each sound tile is highlighted as this occurs. The system presents the corresponding sounds auditorily as the mouse enters each tile. The strength of the mnemonic reminding the student of the sound each tile makes is reduced from 1 above.
3) The student may move the mouse over the letter-sound tiles. Each tile is highlighted as this occurs. Visual mnemonics designed to remind the student of the sound of the letter-sound tile are removed. No sound is played as the mouse moves over the letter-sound tiles
4) The word is presented without being broken up by letter-sound tiles. No other assistance is provided.

The set of words may be chosen from a larger library of possible words. The set may be chosen according to user-specified criteria (e.g. including specific letter combinations that a student may have difficulty with).

It will be understood that mnemonics may be used in many different forms in accordance with the present invention—for example, in some embodiments only auditory mnemonics may be used, with no visual mnemonic.

Different strengths of the support mechanism may be used in other contexts. For example, in FIG. 4d, the representation of a “king” with the letter ‘k’ (shown top-right), which is presented after an incorrect response, may be presented at different strength levels. It may even be displayed at a different strength within the grid 119, than when presented to the student as a prompt. Depending on the intention of the exercise, it may provide less support (to make the student do more work to match the representations) or more support (to reinforce the association between the target and the support mechanism/mnemonic).

FIG. 4e shows an alternative embodiment of the present invention, for teaching segmentation skills. Here, the student is presented with a picture and spoken word for a target (e.g. a picture of a net is shown top-right, and the word “net” is spoken). The student is also presented with a set of letters (or letter combinations) in a grid 119, and must select the correct letters in the correct order for the selected target (i.e. ‘n’, ‘e’, ‘t’). The system may provide different levels of support for that target (e.g. breaking up the spoken word “net” into its component sounds, or showing some of the correct letters). The level of support may depend on the proficiency shown by the student. However, in the particular embodiment shown in FIG. 4e, discrimination is not required between multiple displayed targets (except to discriminate between the displayed letters). Rather, the selected target is simply presented to the student for identification using the displayed letters; the targets in this embodiment are simply words selected for the purpose of teaching the language skill of segmentation.

The second aspect of the present invention may be utilised separately or in conjunction with the first aspect of the present invention.

### Third Aspect

A system implementing the above invention will accordingly comprise display means for displaying a first representation of the targets, and support means for providing a support mechanism, wherein the support mechanism is adjustable in strength, and the support means allows provision of the support at a variety of strength values.

However, such a system need not be a computer system; the system may simply be a set of (building) ‘blocks’ that children commonly play with. For example, for teaching letters, on each side of a block a letter may displayed along with an associated mnemonic, wherein the mnemonic is displayed at a different strength on each side. The blocks may simply be rotated to display the mnemonic at different strength values. FIG. 6 shows a block 180 for the letter ‘d’, with the mnemonic of a dog, at different strengths as shown in FIG. 5a. Similar blocks could be used in accordance with FIGS. 5b and 5c.

Typically, however, a computer system will be used to perform the above-described methods. However, a system may be provided further including presentation means to present a second representation of a selected target to the student (e.g. audio speakers), to prompt the student to identify the selected target from targets displayed by the display means, response means to receive a student response, and a processor to determine whether the response correctly identifies the selected target.

In such an embodiment, the display means could simply be a computer monitor, which could display targets as well as provide the support mechanism as instructed by a compute processor. The response means may, for example, be a mouse, keyboard or microphone adapted to receive student responses, and pass them to the processor.

The processor may also be further adapted to associate, with each target, a student score and a completion score, and to apply a correct response increment or an incorrect response decline to the student score, depending on the student response. Therefore, the system of this aspect of the invention may perform either or both of the methods of the first and second aspects described above.

Of course, similar methods could also be used to assess a student's ability to match representations of targets. This would simply entail attributing numerical values to correct or incorrect responses and reaction times, which could then be compared to normative data if desired.

### Fourth Aspect

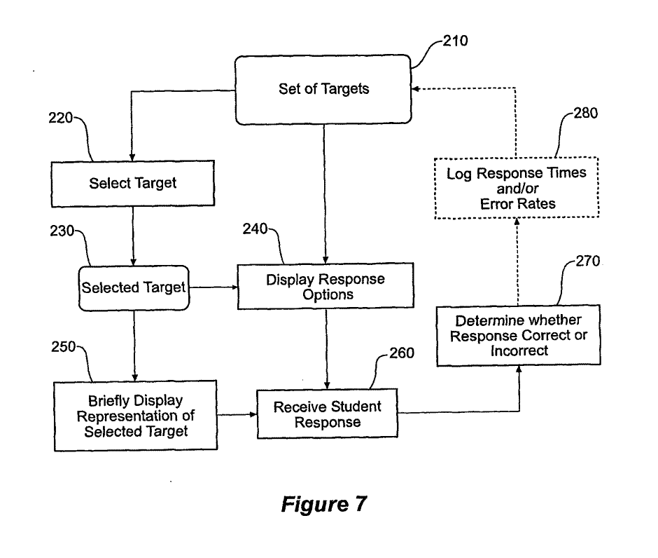

Referring to FIG. 7, the present invention also provides another tool for assessing a student's ability to recognise representations of a set of targets 210. Again, the targets described will be in the environment of literacy, this time being whole words, although the invention could be used of evaluating the strength of a student's neurological representation of any stimuli.

A word 230 is selected 220, and multiple response options are displayed 240. Each response option corresponds to a target, in this instance a target word. FIG. 8 shows two response options displayed, for “bat” and “hat”. Each response option should be familiar to the student—they are preferably trained before-hand in each response option, to ensure there is no confusion between response options themselves. The response options are selected based on the similarity between targets—e.g. targets may be selected which have similar visual or auditory representations. The response options displayed will include a response option associated with the selected target. Of course, more than two response options may be displayed.

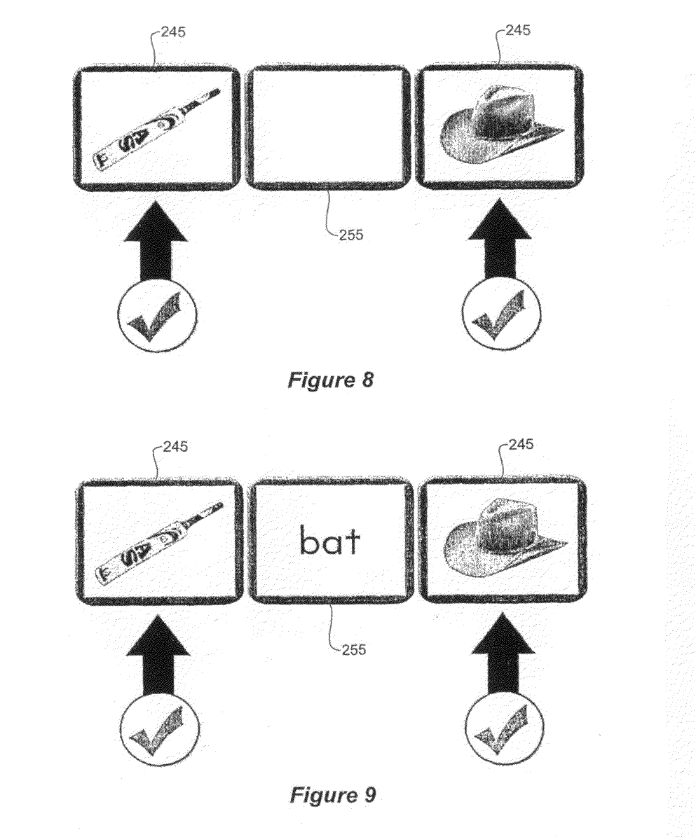

A representation of the selected target 230 is then displayed briefly 250 to the student, prompting the student to identify the response option corresponding to the selected target 230. FIG. 9 shows a selected word 230 displayed in a box 255 between the response options 245. This word is only displayed for a given time—this ensures that the results can be standardised, and no student obtains an advantage over other students. The word may be displayed only for a short time—for instance, less than 1 second. In this embodiment, the word is displayed for approximately 500 milliseconds.

A student response is then received 260 (for example by a mouse-click on a particular response option), and analysed to determine 270 whether it is correct or incorrect. Preferably, the method is repeated many times, and error rates are logged 280 as well as response times. These can then be compared to normative data to make an assessment of the student's ability to distinguish between targets.

To explain further how targets are selected in this embodiment of the present invention, some background theory will now be explained. Whilst not wishing to be bound by theory, the explanation provided will assist in understanding the reasoning behind the fourth aspect of the present invention. Furthermore, an understanding of the following model will also assist in understanding the advantages and purpose of the fifth aspect of the present invention described below.

### Background Model—Visual-Auditory-Motor (VAM) Model of Phonological Representations

Language production and perception occurs through the activation of neurons in the brain. A discussion of how various tasks relate to certain representations or processes in the brain is best held within the framework of a cognitive model.

The Hebbian hypothesis states that the frequent excitation of one neuron to a neighbouring neuron results in metabolic changes in the synapse between them, leading to an increase in synaptic efficacy. Recent research investigating the neural mechanisms of learning suggests that learning indeed occurs through the adjustment of the strength of synaptic connections between neurons (e.g. Antov et al, 2003), providing support for Hebb's hypothesis.

Through an increase in release of neurotransmitter, long lasting changes in the efficacy of the synapse initially results in a “short term memory” effect, and continued activation results in changes in gene activation resulting in growth of the synapse, leading to a long-lasting change in the functioning of the synapse, resulting in “long term memory” (Kandel, 2001). A major consequence of these findings is that cognitive neuropsychological models of learned cognitive processes (e.g. phonological processing) may be constructed based on these fundamental neurological principles with greater confidence.

An in depth discussion of Hebbian principles is beyond the scope of this application, however outlining a few core principles will assist in the explanation of the proposed invention.

According to Hebbian learning principles, recognition of a stimulus occurs following the activation (ignition) of a group of associated neurons representing that stimulus, called a ‘cell assembly’. This applies to many different types of stimulus—for instance, visual recognition of polygons, or for the purposes of the examples given in FIGS. 8 to 9, letters or words. This list is obviously not exhaustive.

“Ignition” of the cell assembly will result if a sufficient a number of neurons in the assembly is activated (through sensory or cortico-cortical fibers) resulting in a spread of activation to other members of the cell assembly, such that the entire cell assembly becomes active. Furthermore, other neurophysiological effects will lead to a suppression of the synapses with adjacent neurons that are not part of the cell assembly, leading to a weakening of connections with unrelated neurons.

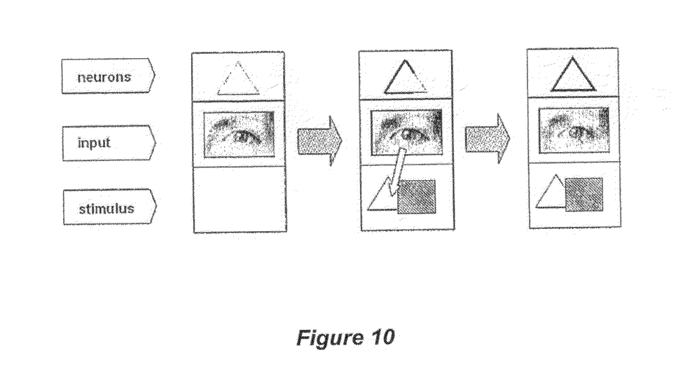

Ignition corresponds to the perception of a stimulus (e.g. a polygon, or a letter or a word) with a previously established neural representation (cell assembly). An illustration of how cell assembly ignition can facilitate stimulus recognition is provided in FIG. 10.

In FIG. 10, partial activation of a cell assembly corresponding to neurons representing a gestalt stimulus (in this case a triangle), results in ignition of the cell assembly due to the activation of associated neurons belonging to the cell assembly, and perception of the stimulus despite its degraded presentation.

As shown in FIG. 10, ignition properties of cell assemblies facilitate the recognition of incomplete or degraded stimuli (Pulvermuller, 1999). A further important implication of this concept is that the stronger the associations between neurons in a cell assembly corresponding to a stimulus, the better the cell assembly is at recognising degraded stimuli, since fewer neurons belonging to the cell assembly are required to facilitate ignition of the entire structure.

Reverberation effects result in stimulus recognition being possible after the removal of the stimulus, since the cell assembly corresponding to the stimulus remains ignited.

Pulvermuller (1999) argues for a hierarchical organisation of cell assemblies, in which sub-ordinate cell-assemblies form the basis of more complex representations further up the hierarchy. The ignition of a high order cell assembly (e.g. the multisensory conceptual information corresponding to the meaning of a word) may consequently involve the ignition of a subset of cell assemblies (e.g. the auditory and visual representations of the word), and concepts that have common features may be represented in more than one subset of the higher-order cell assembly (Pulvermuller, 1999).

It is proposed that phonological representations (the neural representations of the sounds of language) are multisensory cell assemblies corresponding to the auditory, visual and motor representations of the sounds of language. The ‘strength’ of these representations may be evaluated through tasks in which a subject is presented with a stimulus and must identify a corresponding representation indicating correct perception of the stimulus.

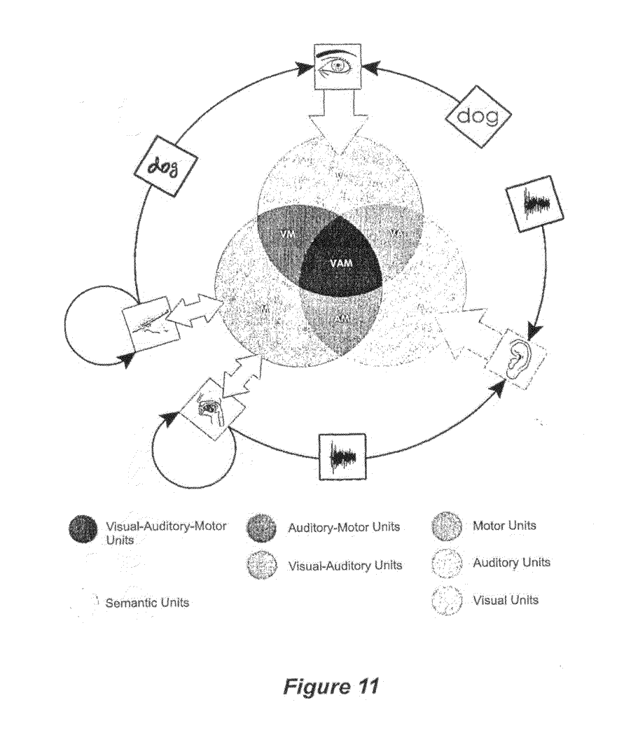

FIG. 11 shows diagrammatically the VAM model of phonological representations. The word “dog” is the stimulus shown—in the brain, this can be associated with the handwritten or typed visual representations of the word “dog”, the articulatory or writing motor representations of the word, or the sound of the spoken word (auditory representations).

### Core Predictions of the VAM Model

The model predicts that:
a system (typically being a cell assembly within a person's brain) with strong phonological representations will identify (i.e. discriminate between) similar stimuli more accurately and more quickly than one with poorly specified representations;
a system with strong representations will perform better with degraded or incomplete stimuli than a system with ‘fuzzy’ representations;
a well-specified system will perform more effectively in identifying more complex stimuli
a strong phonological representations system will correlate with a high vocabulary.

### Similarity

Determining the similarity of stimuli involves a comparison of distinctive features between stimuli. Distinctive feature theory is a prominent component of articulatory and acoustic phonetics, and will be familiar to one skilled in the art. Distinctive features are those features which distinguish stimuli from each other. In terms of the VAM model, features which distinguish a pair of stimuli are the cell assemblies which are not common to both stimuli.

The invention utilises stimuli which have been selected based on the variation of the number of distinctive features between stimuli. Broadly, the auditory similarity between two words may be expressed as a function of the number of phonemes they share, and the number of those phonemes which are in the correct position. Words which differ by only one phoneme (such as /stop/ and /slop/are called minimal pairs (words differing by only one letter/sound). The key discrimination tasks in the invention involve discriminating between minimal pairs whose contrasting segments differ by only one distinctive feature (e.g. voiced/unvoiced, such as /p/ and /b/).

While formal categorisations of articulatory/auditory features exist, there is no corresponding system for categorising the distinctive features of letters. Letter similarity is determined through a similar custom system of categorising structural features, and through the use of similarity judgment studies.

Stimuli are categorised according to the visual and articulatory/auditory similarity of their corresponding representations, in order to facilitate a comparison between auditory and visual discrimination performance. Table 1 below shows a comparison between words that may be targets according to the present invention.

TABLE 1

| | CVC | | | CCVC | | |
|---|---|---|---|---|---|---|
| Condition | ### | ##C | #VC | #### | #CVC | C#VC |
| −V −A | cat leg | mat pot | mat fat | crab plug | plug slug | snip skip |
| | rat peg | tin fan | leg peg | flag skip | clap flap | snack smack |
| +V −A | pin dot | dog pig | pot dot | drip plug | drop prop | slip skip |
| | pig dad | den pan | lap tap | | dress press | slop stop |
| −V +A | tap dog | dip top | dip tip | | trip drip | scar star |
| | cap tin | cap tip | cap tap | | grab crab | school stool |
| +V +A | bat peg | bat dot | beg peg | | prick brick | snack smack |
| | bag dot | mat net | bin pin | | brain drain | skate state |

The left-hand side of the table shows words which have the following pattern of segments: consonant (C)-vowel (V)-consonant (C). The right-hand side of the table shows words which have the pattern: CCVC (note that consonant and vowel segments refer to a segment and not to an individual letter, e.g. “oo” and “ai” comprise individual vowel segments).

In the table, the similarity of the words is categorised as follows: firstly, corresponding segments are shown in the column header with either a ‘C’ (for consonants) or a ‘V’ (for vowels). Differences between the corresponding segments are shown with a ‘#’—i.e. letters having the pattern CVC and sharing only a common last consonant segment are found in the column headed “##C”.

Words which differ by only one segment are known as “minimal pairs” —these can be found in the columns headed “#VC, #CVC and C#VC in Table 1.

The words shown are further categorised as shown by the labels at the left of the table under the heading “Condition”. For the minimal pair words, −V indicates that the contrasting segments in each pair of words are visually dissimilar, whilst +V indicates the contrasting segments are visually similar (i.e. their visual representations are similar). −A and +A indicate the corresponding similarity or dissimilarity in the auditory representations of the contrasting segments.

### Application to the Fourth Aspect of the Present Invention

The present invention is designed to evaluate the strength of the visual and auditory components of neurological representations of stimuli by evaluating a subject's ability to correctly discriminate between stimuli which share visual and auditory features.

In one embodiment of the present invention described herein, all stimuli (or targets) are presented visually (as a word presented on the computer screen). They may also be presented auditorily (as a word presented through the computer's headphones or speakers), with response options presented as pictures. Student responses are collected and analysed.

The method of the fourth aspect of the present invention may be repeated many times. The visual and auditory similarity between the presented stimuli and the representations corresponding to other response options may be varied as the method is repeated, in order to compare performance between similar and dissimilar targets.

Note that even when the visual representations are the representation that is presented, visual similarity need not be the criteria (or the only criteria) used to measure the similarity of the targets. Performance for different types of similarity may be measured: for example, it may be determined that a student only has difficulty distinguishing between visual representations that are visually similar, but not between visual representations of targets which have similar auditory representations.

The similarity of the targets corresponding to the response options may be varied based on similarity criteria—e.g. based on the visual or auditory similarity of a word. Student performance can then be categorised based on the similarity criteria—e.g. that a particular student more readily discriminates between targets that are visually similar than auditorily similar.

Performance may be measured as number of errors made. Performance and reaction times can be compared with normative data to establish whether the subject's score falls within a normal range (e.g. for the student's age). An analysis of error patterns may reveal specific weaknesses with discrimination skills such as the ability to auditorily and/or visually discriminate between words. Given that this kind of task assesses the strength of phonological representations, the system enables one to determine, hopefully at an early stage, whether the student is at risk of literacy or language difficulties, and whether further intervention is needed to assist the student.

Naturally, the fourth aspect of the present invention may be used in relation to assessing different types of targets or different types of representations.

### Fifth Aspect

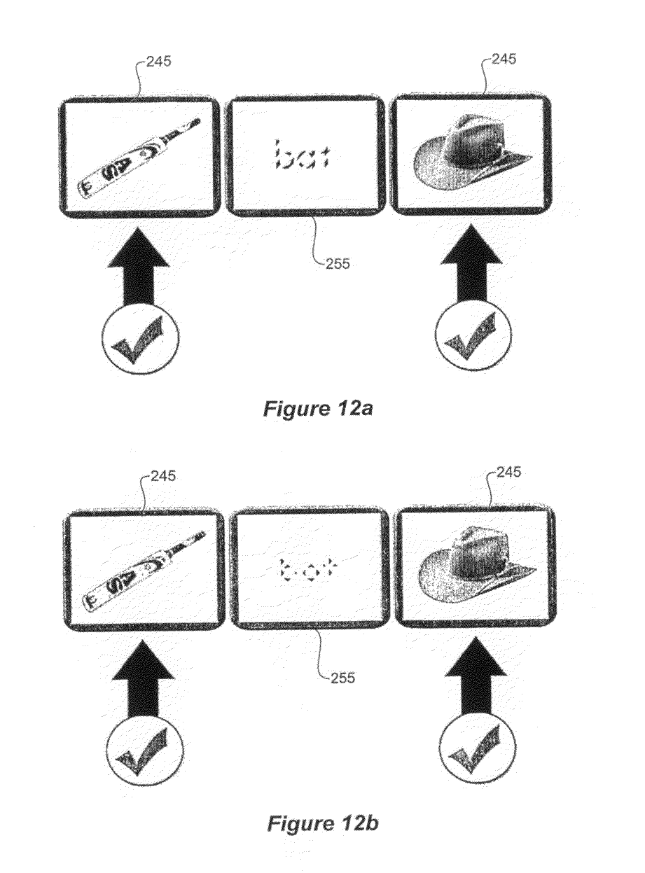

To additionally test the student's ability, essentially the same test may be performed, but displaying 250 the selected target representation in a degraded form. FIG. 12a shows a degradation to the visual representation of the target. The purpose of this is to further test the strength of the phonological representations—the discussion of the VAM model and its application to the fourth aspect of the present invention applies equally to the fifth aspect of the present invention.

To more strenuously test the strength of the phonological representations, the degree of degradation may be modified. FIG. 12b shows a representation that is more degraded than the representation shown in FIG. 12a.

Of course, the target need not be displayed in a visual representation. It may be, for instance displayed in an auditory representation, or in an articulatory representation, and any of these representations may be degraded to make it more difficult to distinguish between targets. For example, parts of an audio recording of the sound of the spoken word “bat” may be removed, or alternatively the recording may be overlaid with noise to make it more difficult to distinguish the target.

Naturally, the fifth aspect of the present invention may be used in relation to assessing different types of targets or different types of representations.

### Sixth Aspect

To perform these methods, a system for assessing a student's ability to recognise representations of targets can be used. The system comprises means for displaying response options, means for displaying a representation of a target, means for receiving a student response, and a processor to analyse the student response to monitor error rates and/or response times.

As can be seen, the system is functional to perform the method of aspects four and five of the present invention.

### Seventh Aspect

Another component of literacy is the ability to break a word down into its component letter groupings or combinations, as shown in FIG. 1. These letter groupings each relate to a sound in spoken language. Accordingly, there is provided a computer system for teaching a student to recognise letter combinations (graphemes). The computer system comprises means to display a word, the word comprising a sequence of letter combinations.

Word in the context above includes made-up or “nonsense” words, which have no meaning in language, but which are useful for training students to use sound-letter combinations for decoding in reading. Each letter combination may comprise one or more letters, e.g “ch”, “ation”, etc—the letter combinations preferably correspond to letter-sound patterns which are pre-taught to a student, preferably through the methods outlined in the first few aspects of the invention. For example, the nonsense word “pheem” consists of the letter-sound patterns “ph”, “ee” and “m”, which correspond to the sounds /f/ /ee/ and /m/. In order to successfully read the word, the student must combine (blend) these sounds together to successfully say the word. The system may thus be used to determine the ability of a student to break a word into constituent grapheme parts or letter combinations, and assemble (blend) these together to successfully decode the word.

The words for display may be chosen from a library of stored words, based on user-specified criteria such as phonological and/or letter properties (e.g. number of sounds or letters, number of syllables, sound/letter structure, or more specific patterns, such as ‘all 1 syllable words with 3 sounds and 4 letters, containing the letters ‘ch’ at the beginning of the word).

In our example, the computer system may obviously display the word “pheem” using conventional means.

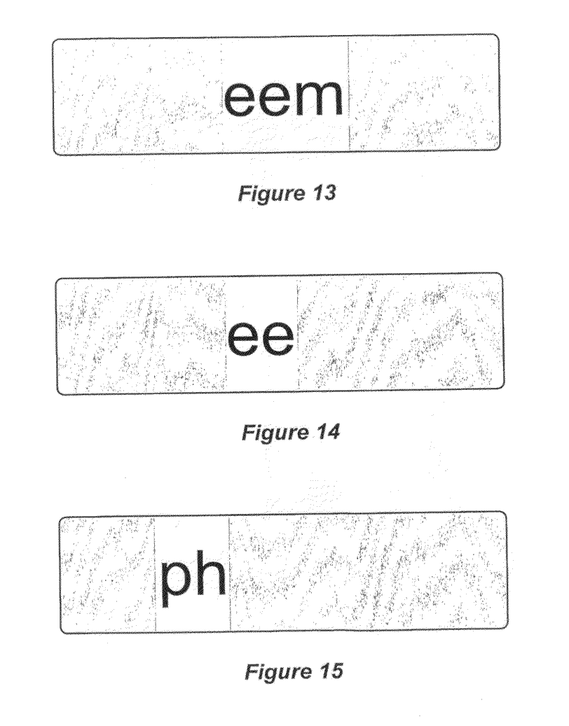

The computer system of the seventh aspect of the present invention further comprises means to allow a user to obscure parts of the word to isolate one or more of the letter combinations. FIG. 13 shows the segment “eem” displayed according to an embodiment of the present invention, whilst the letters “ph” are obscured. Similarly, FIG. 14 shows more parts of the word obscured to isolate just the letter combination “ee”, corresponding to the sound /ee/. Similarly, the letter combination ‘ph’ could be isolated as shown in FIG. 15.

The selection of the letter combinations may be done by dragging the lateral borders of the display box inwards to isolate letter combinations as desired. Alternatively, a user (either a student or a demonstrating teacher) may place their mouse cursor over a particular letter, and that letter or corresponding letter combination may be automatically isolated by the computer system. Note that the system in this case should be able to distinguish between letter combinations that should not be broken down—for instance, the letter combination “ph” in “pheem” should only be shown as a combination, and not as individual letters.

The computer system may also allow a user to present a student with a sound corresponding to an isolated letter combination, or a previously taught mnemonic designed to remind the student of the corresponding sound. That is, supposing the letter ‘k’ is isolated, the mnemonic of a king may also be displayed. A particular student profile may be developed (for instance using earlier aspects of the present invention), and mnemonics may be provided at different strengths depending on the proficiency that has been displayed by the user for a particular letter or letter combination.

The computer system may also provide for the generation of wordlists based on specified properties, and the storage of data regarding a student's progress, including correct/incorrect words or letter-sound patterns. In some embodiments of the invention, this data may be fed into the teaching method designed to teach a set of targets described in the first sections of this document.

Although embodiments of the present invention have been described in the foregoing detailed description, it will be understood that the invention is not limited to the embodiment disclosed, but is capable of numerous rearrangements, modifications and substitutions without departing from the scope of the invention. Modifications and variations such as would be apparent to a skilled addressee are deemed within the scope of the present invention.

It should be noted that the order of the steps of disclosed processes may be altered within the scope of the invention. Furthermore, the methods and systems of the present invention may be applied to other types of targets, including other language structures (e.g. new words, grammatical inflections and syntax, scientific or medical terminology), mathematical constructs (e.g. number recognition, multiplication tables and mathematical concepts), musical constructs (e.g. the recognition of notes or chords), foreign languages (e.g. foreign sound-letter patterns, vocabulary and other language structures), character sets (e.g. phonetic symbols) or other symbols/representations (e.g. representations corresponding to people, places, concepts or objects).

Although the aspects of the present invention have been separately described above, this is simply for the purposes of clarity. Features described in relation to one aspect may be combined with another aspect of the present invention. Indeed, entire aspects of the present invention may in some instances be combined—for instance, a method comprising both the first and second aspects is specifically disclosed. Furthermore, the assessment aspects of the present invention may be used to identify appropriate targets for teaching using the teaching aspects of the present invention.

The present invention can also be implemented in numerous ways, including as processes, apparatus, systems, or a computer readable media such as computer readable storage media or computer networks wherein program instructions are sent over optical or electronic communication links.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any prior art in this specification is not, and should not be taken as, an acknowledgment or any form of suggestion that such prior art forms part of the common general knowledge.

1. A method for teaching a set of targets to a student comprising:
(a) associating, with each target, a student score and a completion score;
(b) selecting a target for which the student score has not reached the completion score;
(d) prompting the student to identify the selected target;
(e) receiving a student response; and
(f) if the response correctly identifies the selected target, applying a correct response increment to the student score associated with the selected target;
or
if the response does not correctly identify the selected target, applying an incorrect response decline to the student score associated with the selected target.

2. A method as claimed in claim 1, further comprising:
(c) displaying multiple different targets to the student, including the selected target.

3. A method as claimed in claim 2, wherein in step (c) the multiple different targets are displayed to the student in a first representation, and in step (d) the student is prompted by presenting the selected target to the student in a second representation.

4. A method as claimed in claim 3, wherein the first representation is a visual representation, and the second representation is an auditory representation.

5. A method as claimed in claim 3, wherein if the response incorrectly identifies the selected target, the first representation of the selected target is displayed to the student, to again prompt the student to identify the selected target from the displayed targets.

6. A method as claimed in claim 2, wherein in step (c), all targets in the set are displayed to the student.

7. A method as claimed in claim 2, wherein in step (c), targets are not displayed for which the student score has reached the completion score.

8. A method as claimed in claim 2, wherein commonly confused targets are displayed adjacent each other.

9. A method as claimed in claim 1, wherein if the response does not correctly identify the selected target, the method further comprises applying an incorrect response decline to the student score associated with any target identified in the student response.

10. A method as claimed in claim 1, wherein each student score has an initial value, and the incorrect response decline resets the student score to the initial value.

11. A method as claimed in claim 1, wherein the targets are letter-sound relationships.

12. A method as claimed in claim 1, wherein step (a) further comprises associating a support mechanism with each target, and the support mechanism is provided to the student for the selected target.

13. A method as claimed in claim 12, wherein the support mechanism is adjustable in strength, and strength of the support mechanism is associated with the student score such that the incorrect response decline increases the strength of the support mechanism.

14. A method as claimed in claim 12, wherein the support mechanism is adjustable in strength, and the strength of the support mechanism is associated with the student score such that the correct response increment decreases the strength of the support mechanism.

15. A method as claimed in claim 12, wherein the support mechanism is a mnemonic.

16. A method as claimed in claim 15 wherein at it strongest the mnemonic completely replaces the selected target.

17. A method as claimed in claim 15, wherein at its weakest, the mnemonic is not provided.

18. A method as claimed in claim 13, wherein the support mechanism has three or more possible strengths.

19. A method for teaching a set of targets to a student comprising:
(g) associating a support mechanism with each target, the support mechanism being adjustable in strength and having a strength value;
(h) selecting a target;
(j) prompting the student to identify the selected target;
(k) providing the support mechanism to the student, at a strength corresponding to its strength value, to assist the student to identify the selected target;
(l) receiving a student response; and
(m) if the response correctly identifies the selected target, decreasing the strength value of the support mechanism associated with the selected target;
or
if the student response incorrectly identifies the selected target, increasing the strength value of the support mechanism associated with the selected target.

20. A method as claimed in claim 19, further comprising:
(i) displaying multiple different targets to the student, including the selected target,
and wherein the student is prompted to identify the selected target from the displayed targets.

21. A method as claimed in claim 20, wherein in step (i), multiple different targets are displayed to the student in a first representation, and in step (j) the student is prompted by presenting the selected target to the student in a second representation.

22. A method as claimed in claim 21, wherein the first representation is a visual representation, and the second representation is an auditory representation.

23. A method as claimed in claim 21, wherein the support mechanism is provided along with the selected target when it is displayed step (i), and also along with the selected target when it is presented in step (j).

24. A method as claimed in claim 19, wherein the support mechanism is a mnemonic.

25. A method as claimed in claim 19, wherein at its lowest strength value, the support mechanism is not provided.

26. A method as claimed in claim 19, wherein the strength value has three or more possible values.

27. A method as in claim 19, wherein the targets are letter-sound relationships.

28. A system for teaching a set of targets to a student comprising:
display means for displaying a first representation of the targets;
presentation means for presenting a second representation of the targets;
support means for providing a support mechanism, wherein the support mechanism is adjustable in strength, and the support means allows provision of the support at a variety of strength values.

29. A system as claimed in claim 28, further comprising:
presentation means to present a second representation of a selected target to the student, for the student to identify the selected target from targets displayed by the display means;
response means to receive a student response; and
a processor to determine whether the response correctly identifies the selected target.

30. A system as claimed in claim 29 wherein the processor is further adapted to associate, with each target, a student score and a completion score, and to apply a correct response increment or an incorrect response decline to the student score, depending on the student response.

31. A method of assessing a student's ability to recognise representations of a set of targets, comprising:
(n) selecting a target;
(o) displaying multiple response options, each response option known by the student to correspond to a target, one response option corresponding to the selected target;
(p) for a given time, displaying a representation of the selected target to the student;
(q) receiving a student response, from the response options;
(r) determining whether the student response correctly identifies the response option corresponding to the selected target; and
(s) repeating steps (n) to (r), varying response options in step (o) to vary the similarity of the corresponding targets.

32. A method as claimed in claim 31, wherein in step (s), the similarity of the response options are varied in accordance with a plurality of similarity criteria.

33. A method as claimed in claim 31, wherein the similarity criteria include similarity of visual representations of the corresponding targets, and similarity of auditory representations of the corresponding targets.

34. A method of assessing a student's ability to recognise representations of a set of targets, comprising:
(m) selecting a target;
(n) displaying multiple response options, each response option known by the student to correspond to a possible target, one response option corresponding to the selected target;
(o) for a short time, displaying a representation of the selected target to the student;
(p) receiving a student response, from the possible response options; and
(q) determining whether the student response correctly identifies the selected target,
wherein the representation of the selected target displayed in step (n) is degraded.

35. A method as claimed in claim 31, wherein the given time is a short time.

36. A system for assessing a student's ability to recognise representations of targets, comprising:
means for displaying response options;
means for displaying a representation of a target;
means for receiving a student response; and
a processor to analyse the student response to monitor error rates or response times.

37. A computer system for teaching a student to recognise letter combinations comprising:
means to display a word, the word comprising a sequence of letter combinations; and
means to allow a user to obscure parts of the word to isolate one or more of the letter combinations.

38. A computer readable medium encoded with data representing a computer program that can be used to direct a programmable device to perform the method of claim 1.

39. A computer readable medium encoded with data representing a computer program that can be used to direct a programmable device to perform the method of claim 19.

40. A computer readable medium encoded with data representing a computer program that can be used to direct a programmable device to perform the method of claim 31.
